(19) United States
(12) Patent Application Publication
(10) Pub. No.: US 2025/0098597 A1
(43) Pub. Date: Mar. 27, 2025

(54) DEGRADABLE MULTI-LAYERED PROPAGANT VESSEL

(71) Applicant: FASTER FORESTS INC., Acheson (CA)

(72) Inventors: Christian WIESENTHAL, Carlsbad, CA (US); Douglas JAMES, Burnaby (CA)

(21) Appl. No.: 18/847,124

(22) PCT Filed: Mar. 7, 2023
(86) PCT No.: PCT/CA2023/050296

§ 371 Date: Sep. 13, 2024

Related U.S. Application Data
(60) Provisional application No. 63/320,186, filed on Mar. 15, 2022.

(51) Int. Cl. A01G 9/029; B32B 3/26

(52) U.S. Cl. CPC A01G 9/0291; B32B 3/266; B32B 2250/02; B32B 2307/7163; B32B 2307/724; B32B 2307/726; B32B 2439/46

(57) ABSTRACT

A plant propagation module has an outer layer and an inner layer. The outer layer is permeable to water and air. The inner layer is disposed within the outer layer such that the outer layer surrounds the inner layer. The inner layer forms an inner cavity and is substantially impermeable to water. Growth matrix and one or more plant propagants are positioned within the inner cavity. Each of the inner layer and the outer layer are degradable, with the inner layer degrading faster that the outer layer to permit water and air to access the growth matrix and the one or more plant propagants.

### TECHNICAL FIELD

This relates to propagant vessels, and in particular, multi-layered structures that are used to carry propagants, such as seeds, and growth matrix.

### BACKGROUND

Currently, there are two primary methods of afforestation, reforestation, and revegetation (“ARR”) including land reclamation, and these include the direct planting of seedlings and seed casting. Direct planting of seedlings is a multi-step approach consisting of planting and growth of seeds in a green house or controlled environment until a minimum height is reached for the plant or “shoot” prior to being transported to the desired site of plantation and inserted into the soil. The process of growing these plants in a controlled setting can vary and the length of time required for each plant also varies depending on the species and geographical location. Vegetation that is grown in a controlled setting prior to being physically transported may require over 2 years of growth in a green house. This process requires high operational, overhead, direct and indirect labour costs as well as the use of a significant volume of resources. This process also generates a high volume of plastic waste, as seedlings may be transported individually in plastic containers, which are then disposed of. All of these factors can lead this process to be extremely inefficient as there is significant time and resources invested in the life of the plant and there are far too many variables that may negatively impact the plant in this time frame. There are several challenges in the process of physical transportation and planting of the vegetation that increases the fragility of this process and leads to a very low success rate in ARR efforts.

The other method of rapid ARR is the process of seed casting where seeds of varying species of vegetation are cast and spread over a geographical location using mechanical means of dispersion and distribution. This process has the benefit of being low operational cost as compared to planting methods, however it has a 3% or lower germination success rate which represents a very high waste of seeds.

There are several external factors that limit the success of seedling planting or seed casting. The climatic conditions in a geographical region have significant influence over plant growth. Some regions present optimal growth conditions and some regions will inhibit the germination, growth or cultivation of vegetation. Climatic conditions involve multiple factors including: volume of precipitation, relative humidity and hours of sunlight. Another example of an external limiting factor is the soil and ground condition. The presence of the correct nutrients, moisture, and pH will impact the fertility of the ground conditions and can impact the successful growth of plants. Other external agents include the presence of insects, fungi, weeds, predatory species/animals that feed on seeds and vegetation.

U.S. Pat. No. 5,799,439 (MacGregor) entitled “Protective enclosures for seeds” describes an enclosure for that provides a self-contained environment for protecting seeds in their early growth stages.

### SUMMARY

According to an aspect there is provided a vessel for plant propagants, comprising an outer layer that is permeable to water and air, and an inner layer within the outer layer that is adapted to seal around an inner cavity, wherein each of the inner layer and the outer layer are degradable, the inner layer degrading faster than the outer layer to permit water and air to access the inner cavity.

According to other aspects, the vessel may comprise one or more of the following features, alone or in combination: the inner layer and the outer layer may degrade when exposed to water; the inner layer may degrade sufficiently to unseal the inner cavity within a period of 1 to 2 days; and the outer layer may retain structural integrity over a period of 30 to 60 days after the inner layer degrades sufficiently to unseal the inner cavity.

According to an aspect, there is provided a plant propagation module, comprising an outer layer that is permeable to water and air, an inner layer disposed within the outer layer such that the outer layer surrounds the inner layer, the inner layer forming an inner cavity and being substantially impermeable to water and air, and a growth matrix and one or more plant propagants positioned within the inner cavity, wherein each of the inner layer and the outer layer are degradable, the inner layer degrading faster than the outer layer to permit water and air to access the growth matrix and the one or more plant propagants.

According to other aspects, the plant propagation module may comprise one or more of the following features, alone or in combination: the inner layer and the outer layer may degrade when exposed to water; wherein the outer layer may comprise a screen or a mesh; the inner layer may degrade sufficiently to unseal the growth matrix within a period of 1-2 days upon exposure to water; the outer layer may retain structural integrity for a period of 20 to 40 days after the inner layer degrades sufficiently to unseal the inner cavity; the inner cavity may have a volume of between 1.27 cm³ and 20.32 cm³; and the one or more plants propagants may comprise one or more seeds.

According to an aspect, there is provided a multi-layered seed vessel comprising a rapid degrading sealing inner layer and a porous slow degrading outer layer designed to hold and carry growth medium and one or more plant propagants.

According to an aspect, there is provided a degradable multi-layered seed vessel, comprising an inner layer that degrades faster than the outer, permeable layer. The inner scaling layer is designed to degrade in the presence of water faster than the outer layer to allow air and moisture to pass into the seed vessel. The outer layer is permeable to air and water and provides structural supports to growth matrix and seeds after the inner sealing layer degrades. The permeability of the outer layer may be defined by the material selected or by pores or apertures formed in the outer layer. The pores or apertures may be cut or punched into the outer layer, or the outer layer may be formed as a screen or mesh, either woven or non-woven. A seed module may be formed by encapsulating growth media and one or more seeds within the seed vessel. The movement of fluids into the seed vessel activates the seed module and allows moisture to be retained to begin the process of seed germination.

According to another aspect, the outer layer is degradable at a slower rate than the inner layer, which may provide a structural support for the contents of the seed module after the inner layer degrades. The outer layer is permeable, such as by way of pores or apertures that are sufficient to allow the flow of fluids such as water and air in and out of the seed vessel. The outer layer may be designed to protect the contents from washing away in the event of high volumes of precipitation, wind or other environmental factors, while allowing seedlings to grow through its orifices The outer layer may be used to provide balance and control to the seed and contents of the seed vessel. The inner and outer layers may be designed with the growing conditions in mind to promote successful germination and growth of the one or more seeds, which are provided with a suitable volume of moisture, micronutrients, macronutrients and other supplemental compounds deemed beneficial for the life and growth of vegetation from a seed, some of which may be previously stored within the seed module, in which case the seed vessel is intended to retain the desired components and some of which may be obtained from the environment, in which case the seed vessel is intended to permit the components to enter the seed vessel.

According to another aspect, the permeability of the outer layer may vary depending on the seed blend, climatic zone, seed species, and environmental conditions, and may be provided by apertures. The size of the apertures may be any suitable size, such as from 1/16″ up to 1″. The size of the apertures may affect the functionality or structural integrity of the outer layer.

According to another aspect, the multi-layered seed vessel may comprise first and second layers of materials with different rates of degradation. The layers may be of a similar material modified to provide the desired rates of degradation, or different materials. One or both layers may be derived from poly lactic acid (PLA), a poly vinyl alcohol (PVA), a lignocellulosic based fiber compound held together by resins and plasticizers, other biodegradable and water-soluble compounds that may be a synthetic blend of polymer or a natural based composition, or combinations or blends thereof. The outer layer may be comprised of the same base composition as the inner layer with some modifications that provides a desired rate of degradation. One or both layers may be a composite material or carry a coating to provide desired properties that may be beneficial during storage, transportation, or deployment, for example.

According to another aspect, the thickness of each layer may be selected based on various factors, such as climatic zone, seed blend, environmental conditions, seed species, time of application, and client/end-user preference. These and other factors may be used to determine a suitable composition and thickness in order to ensure a sufficient rate of degradation, or relative rates of degradation, in the event of moisture for the inner layer and/or the outer layer. These parameters may also be considered when determining the thickness, screen size, compositional blend of the outer layer.

In other aspects, the features described above may be combined together in any reasonable combination as will be recognized by those skilled in the art.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a top view of a seed vessel.

FIG. 2 is a side elevation view in section of the seed vessel of FIG. 1.

FIG. 3 is a side elevation view in section of the seed vessel of FIG. 1 after activation and with the inner layer degraded.

FIG. 4 is a side elevation view in section of an established seedling.

FIG. 5 is a schematic view of a machine for forming the seed vessel of FIG. 1.

FIG. 6 depicts seeds and growth matrix being inserted into an inner layer of a seed vessel.

FIG. 7 depicts an inner layer being inserted into an outer layer of a seed vessel.

### DETAILED DESCRIPTION OF PREFERRED EMBODIMENTS

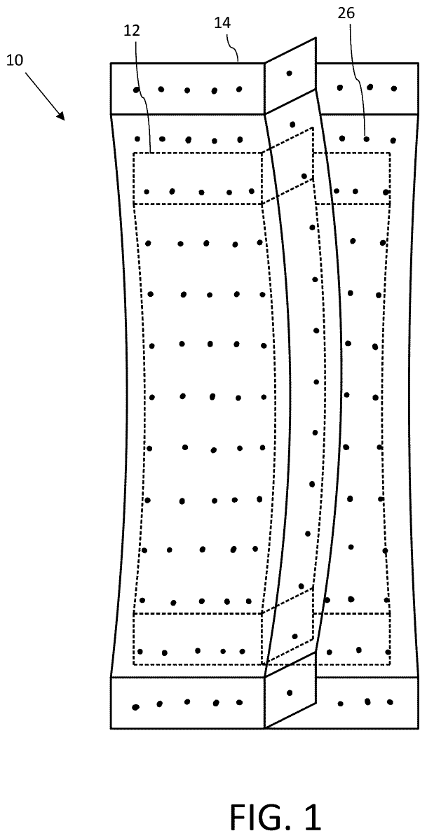

There will now be described a degradable multi-layered propagant vessel, generally identified by reference numeral 10, with reference to FIG. 1 through FIG. 7.

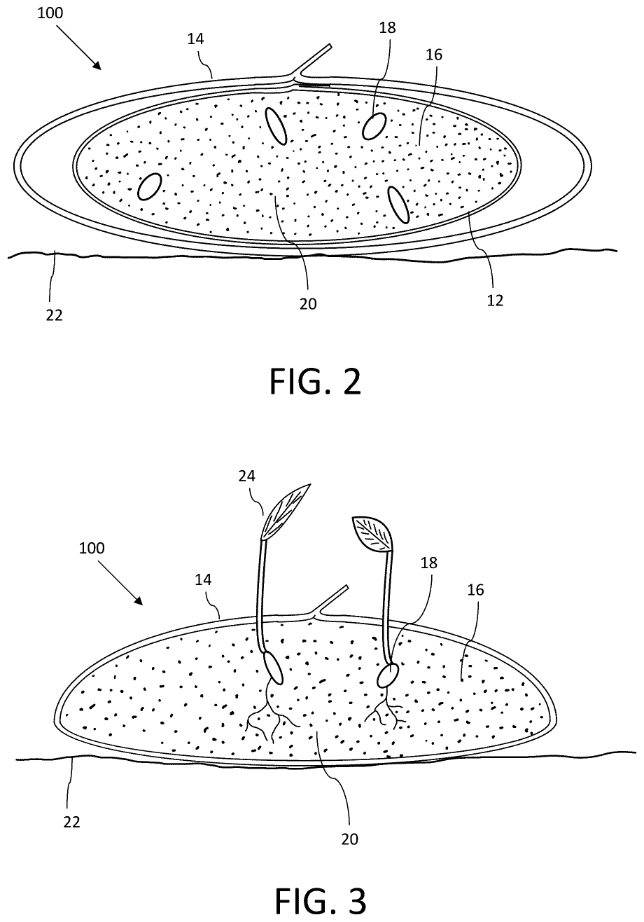

Referring to FIG. 2, propagant vessel 10 has an inner layer 12 that degrades in the presence of water or moisture and a permeable outer layer 14 that is degradable at a slower rate than inner layer 12. Propagant vessel 10 is intended to encapsulate a growth matrix 20 and one or more plant propagants 18, and may be used to promote growth of vegetation, such as during afforestation, reforestation, or revegetation (ARR) activities.

In the following discussion, plant propagants may be referred to as seeds 18, and propagant vessel 10 may be referred to as a seed vessel, with the understanding that other types of propagants may be included in vessel 10 that are capable of growth as a viable specimen after being packaged and distributed, as discussed below. Other types of plant propagants other than seeds may include germinated seeds, seedlings, leaf cuttings, stem cuttings, bud cuttings, crown divisions, spores, and the like. The propagants may be selected based on the preferences of the user and the characteristics of the location where vessel 10 will be distributed. The propagants may be a mixture of different types of propagants,, multiples of the same type, or a single propagant. In many ARR activities, the propagants will be tree seeds or other types of vegetation that would otherwise take longer to become established or that would be most likely to promote the rehabilitation of the land.

Seed vessel 10 may be used as an alternative to other seed broadcasting approaches and may improve the efficiencies in ARR efforts by increasing germination rates of seeds and reducing seed waste and operational costs relative to the results achieved.

Growth matrix 20 is contained within an inner cavity 16 that is formed by inner layer 12. Various types of growth matrix 20 may be suitable and may be enriched with micronutrients, macronutrients and other supplemental compounds deemed beneficial to help a seed germinate and grow. Growth matrix 20 may be selected according to the seed 18 being carried, its characteristics as it progresses through the stages of growth, including the point at which the resulting vegetation outgrows seed vessel 10. Growth matrix 20 may be dry when placed within the seed vessel in order to reduce the likelihood of premature germination of the seed, and/or premature degradation of inner layer 12.

As used herein, a degradable material is capable of decomposing chemically or biologically, wholly or in part, such that the material loses structural integrity. This may include dissolvable materials, biodegradable materials, compostable materials, or materials that lose structural integrity to break down into smaller components without the material as a whole undergoing a chemical or biological change. The material may be designed to degrade under certain conditions, such as a certain level of moisture, acidity, bacteria, organisms, etc. A material may be provided that degrades sufficiently to minimize or avoid leaving a measurable residue, or that avoids any measurable environmental impact. The inner and outer layers 12 and 14 of seed vessel 10 may be designed to promote the successful germination one or more seeds 18, which may enable faster and more effective ARR. Vessel 10 may benefit the one or more seeds 18 and resulting seedlings 24 by adapting to the requirements of the seed as the life cycle of the seed progresses. For example, early stages of seed growth and germination may rely on a desired amount of water for that seed, which may or may not be stratified and/or dormant. An inner, sealing layer 12 that degrades faster than an outer, permeable layer 14 may be used to allow early stages of seed growth by exposing the seed and growth media to water and air, while outer layer 14 provides structural integrity as the seed germinates. Outer layer 14 may have perforations 26 that allow moisture and/or air to come into contact with inner layer 12, in order to start the degradation process of inner layer 12. Perforations 26 may include the openings that are formed in a sheet of material, or they may be openings that are fundamental to a material, such as an outer layer 14 that is made from a screen or mesh, which may be designed to achieve and maintain moisture at a desired level or within a desired range, and which may include a consideration of the composition of matrix 20 and seeds 18. Outer layer 14 may be designed to retain sufficient structural integrity until the seed has reached a stage at which it is more likely to be viable. Alternatively, the outer layer may be designed to lose structural integrity once it is no longer beneficial to the growth of the seed. As noted above, seed vessel 10 may be used to assist ARR efforts through seed casting by providing more control over the growth media 20 of the seed over a longer, and preferably defined, period of time.

FIG. 1 depicts a seed vessel 10 with inner and outer layers 12 and 14 formed into a desired shape. In some examples, such as depicted in FIG. 1, this may be done using a thermal seal or other mechanical forms of bonding. Seed vessel 10 may vary in size-based length, width and height of seed vessel 10 in order to accommodate different volumes of a seed growth matrix and seeds. In some examples, the volume within inner cavity 16 may be between 1.27 cm³ and 20.32 cm³.

FIG. 1 depicts a seed vessel 10 in which each of the inner and outer layers 12 and 14 are formed by sealing the edges of inner and outer layers 12 and 14, respectively. Referring to FIG. 2, inner layer 12 holds seed growth matrix 20, seeds 18, and other components that may be resources and nutrients, or may be used to deliver resources and nutrients, to promote seed growth. Outer layer 12 may loosely fit around inner layer 12 to allow for expansion of growth matrix 20 once exposed to water, as shown in FIG. 3. The thickness of each layer 12 and 14 may vary and is dependent on the specific end use and application of the preferred embodiment. The properties of inner and outer layers 12 and 14 and the properties of the chosen seed growth matrix 20 may be used to promote the desired growth conditions, nutrients and other resources, moisture, homeostatic balance, and structural integrity. Seed vessel 10 may be designed to promote delivery of required moisture, nutrients, and resources to the one or more seeds 18 both in the short early stages of growth and the long-term delayed stages of growth for a seed and seedling 24. It is understood that the seed growth matrix 20 and one or more seeds 18 selected for each seed vessel 10 may be dictated by the local environment and conditions of the jurisdiction in which seed vessels 10 are to be distributed.

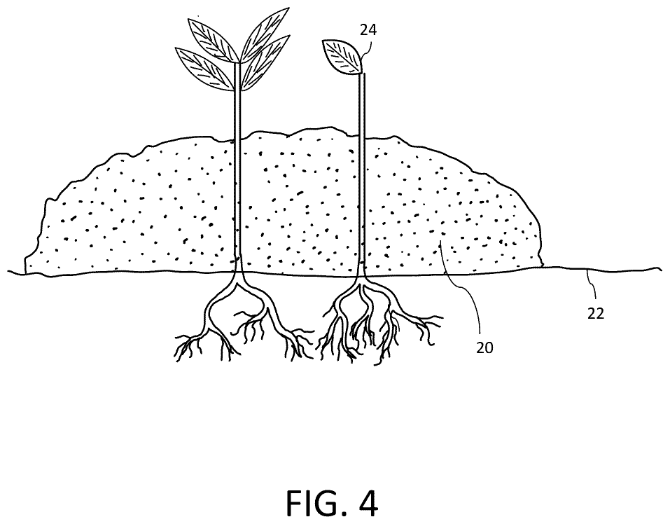

Referring to FIG. 3, inner layer 12 may be designed to degrade rapidly once the seed module has been deployed, such as in the presence of water. The degradation of inner layer 12 may activate the one or more seeds 18 to initiate the process of seed growth and germination. Prior to degradation, the inner layer may be used to seal the seed growth matrix and tree seeds within the seed module, as is shown in FIG. 2. Inner layer 12 may be designed to degrade in the presence of moisture conditions that allows for the growth cycle of one or more seeds 18. It will be understood that inner layer 12 need not fully degrade in order to allow air and water to access the growth matrix therein. Instead, the rate of degradation may refer to the portion inner layer that seals the permeability or apertures in the outer layer. Once the outer layer is unsealed, such as by opening the apertures, air and water may enter the seed module and the remainder of the inner layer may degrade at another rate. Once seedling 24 has successfully rooted and is able to draw resources from the surrounding soil, inner and outer layers 12 and 14 should be fully degraded, or degraded sufficiently to avoid interfering with the future growth of seedling 24, as shown in FIG. 4.

In one example, inner layer 12 may degrade sufficiently to unseal growth matrix 20 within a period of 1-2 days once exposed to certain environmental conditions, such as water, and outer layer 14 may retain structural integrity for a period of around 4 weeks,, or between 20-40 days after inner layer 12 degrades sufficiently to unseal inner cavity. The target range of degradation may be a design parameter based on the conditions that are expected to be encountered. Seed vessel 10 may be designed to accommodate time periods that are less or more than these ranges. In addition, environmental conditions may vary, depending on the climate and zone of the area in which seed vessels 10 are to be distributed. As such, degradation may be initiated by a certain level of water, which may result from precipitation or groundwater, exposure to sunlight, etc.

The composition of inner and outer layers 12 and 14 may be any suitable material that allows for the desired degradation rates. Examples of materials that may be incorporated into the inner and/or outer layers include a resin polymerized together; a blend of different synthetic polymers; a single cellulose-based fiber; a blend of lignocellulosic and cellulosic fibers formed together; polyvinyl alcohol; polyethylene glycol; polyacrylamides; polyacrylic acid; poly lactic acid; cellulose-based fiber such as flax, hemp, wheat, straw; or a blend of cellulose-based fibers and other compostable naturally derived fibers. It is understood that the materials may be suitable combinations of these materials or others, and the materials may be further modified with the use of plasticizers, resins, glues, binders, and other surface modifying agents. Modifying agents may be used to impact rate of degradation, and the rate of moisture and air intake into the seed growth matrix 20, one or more seeds 18, and seedlings 24. These may be selected depending on the geographical location, environmental conditions, the type of seed, and user preference. The composition of inner and outer layers 12 and 14 may be based on similar materials with different additives or modifying agents, or may be different materials altogether. For example, in addition to additives that modify the rate of degradation between inner and outer layers 12 and 14, outer layer 14 may have additives or materials that improve the strength of the material, while inner layer 12 may have additives or materials that improve the sealing capability, or that provide limited air and water scavenging abilities within the scaled envelope to protect the seed during storage and transport.

As it is desirable that ARR efforts do not leave any negative environmental impacts, both inner and outer layers 12 and 14 of seed vessel 10 may be fully degradable.

As discussed previously, outer layer 14 may be sufficiently permeable to allow air and water to access inner layer 12 and ultimately the growth matrix 20 and one or more seeds 18 once inner layer 12 has degraded sufficiently. The permeability may be based on the type of material selected, or may be mechanically formed into the layer, or may be a structural feature of the layer. For example, a material may be selected that is permeable to air and water. Alternatively, the permeability may be due to apertures 26 or pores formed into the material such as by using a cutting or punching die, or may be openings formed into the material, such as by forming outer layer 14 into a screen or mesh. The size of apertures 26, such as the screen size, used to create the porosity of outer layer 14 may be selected for optimal use in varying climatic conditions. For example, lower precipitation regions may require a larger screen size and higher precipitation regions may require a smaller screen size. The mesh or screen size may range from 1/16 inch up to a 1-inch opening. The size of the openings may be based on a function of precipitation and sunlight. The screen size may be selected to ensure that a volume of moisture retained within the seed vessel tree growth medium matrix is balanced as a seed may be drowned if exposed to an excess volume of water and inversely, a seed may dry out if it is not exposed to a sufficient volume of water. The outer layer may be formed from a continuous film with punched out openings, or a plurality of individual strands woven together to create a mesh-like film. The outer shell layer of the seed vessel seed vessel serves as a structural component that provides form and function to allow for enhanced control and balance of moisture and nutritional content balance inside the seed vessel seed vessel.

Referring to FIG. 3, the activated vessel 10 may have an expanded form relative to the inactive vessel 10 due to moisture intake. The inner layer will be rapidly degraded once vessel 10 is activated. Factors that impact the activation of the preferred embodiment may include but are not limited to moisture (relative humidity), time, sun, and soil conditions. Seed vessel 10 may be manufactured with varying thicknesses to each individual layer in order to optimize the field performance and deployment of the seed vessels. The thickness of each film will impact the durability, longevity, tensile strength, elasticity, flexibility, and rate of degradation at each layer. The thickness of each layer may be between 0.0254 mm to 2.54 mm thick. The thickness of each layer of film for seed vessel 10 may or may not be impacted by topographic and other environmental conditions, climate region, rate of deployment and the relative time in the year in which the seed vessels will be deployed in the desired regions.

An example of a manufacturing process will be briefly described. In the depicted example, the inner layer is made from a material that is conducive to being formed as a blown film. The blown film may have a specified diameter that matches the desired width of the seed vessel, such that, in order to create a sealed layer, the top and bottom edges may be sealed, such as by heat welding. Typically, only the bottom edge will be sealed initially to form an inner volume that may then be filled with growth matrix and seed. The remaining edge may then be sealed to complete the seed module.

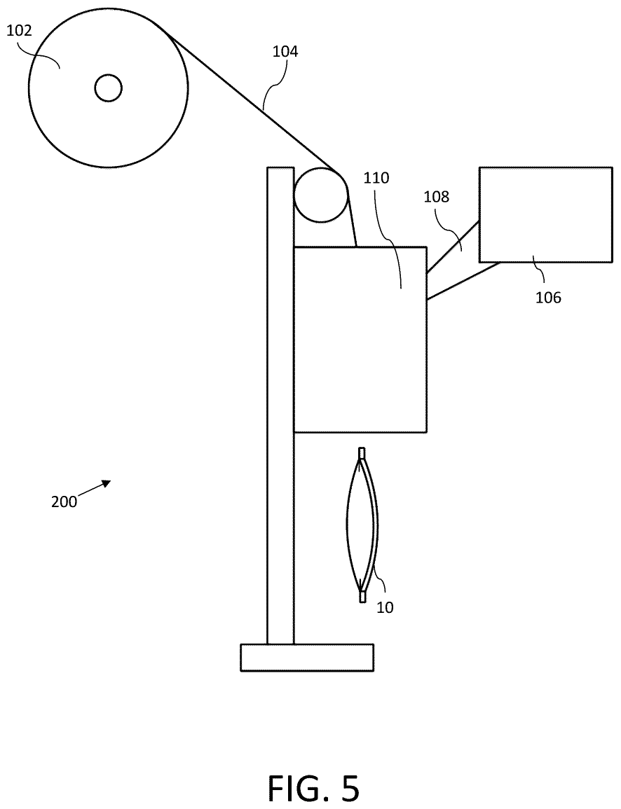

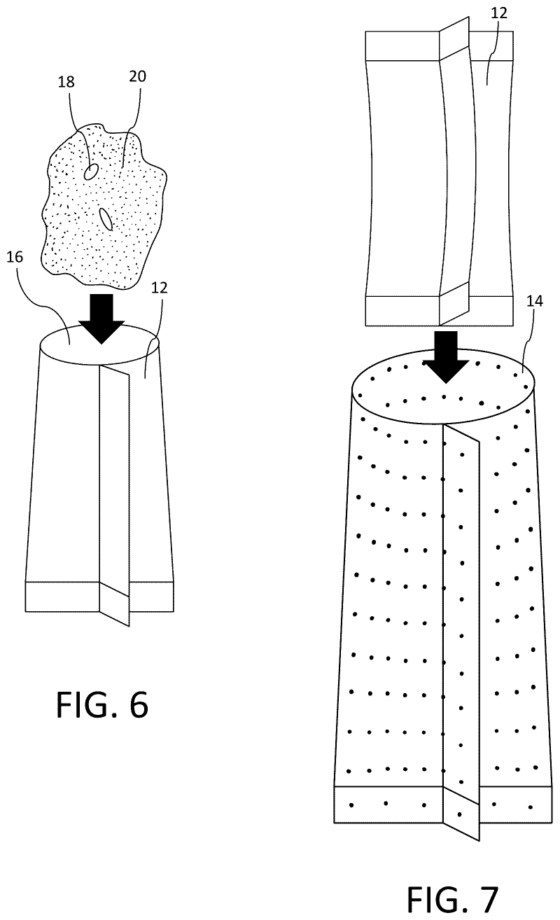

Referring now to FIG. 5 to FIG. 7, seed vessel 10 may be formed in a machine 200 by using rolls of material 102, that are fed into forming block 110 of the machine. Rolls of material 102 may be either the material of inner layer 12 or outer layer 14, and two machines 200 that operate similarly may be used in the manufacture of seed vessel 10, as will be detailed below. A first machine 200 may both fill inner layer 12 of seed vessel 10 with matrix 20 and seal inner layer 12, and a second machine 200 may form outer layer 14 around inner layer 12, as shown in FIG. 6 and FIG. 7, respectively.

Referring to FIG. 5, inner layer 12 filled with matrix 20 and one or more seeds 18 may be formed as follows. A sheet of material 104 is unrolled from roll 102 and fed into forming block 110. Sheet of material 104 is shaped into a tube, with a seal being formed along a bottom edge and a side edge to form inner cavity 16. Matrix 20 and one or more seeds 18 is then fed into forming block 110 through a hopper 108 into inner cavity 16 of inner layer 12. Matrix 20 and one or more seeds 18 may be automatically portioned out as machine 200 operates. After being filled, a top edge of inner layer 12 is sealed. A similar process is used to form outer layer 14 around inner layer 12. Roll of material 102 may be provided that has perforations 26 already formed in it, or perforations 26 may be formed after being unrolled into sheet 104, but before being formed into outer layer 14. A similar process may be used to fill outer layer 14, however instead of a mixture of matrix 20 and seed(s) 18, filled inner layer 12 is fed into a cavity formed in outer layer 14 through hopper 108.

In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be one and only one of the elements.

The scope of the following claims should not be limited by the preferred embodiments set forth in the examples above and in the drawings but should be given the broadest interpretation consistent with the description as a whole.

What is claimed is:

1. A vessel for plant propagants, comprising:
an outer layer that is permeable to water and air;
an inner layer within the outer layer that is impermeable to water and air, and
growth media and one or more plant propagants sealed within an inner cavity defined by the inner layer;
wherein each of the inner layer and the outer layer are degradable, the inner layer degrading faster than the outer layer to permit water and air to access the inner cavity.

2. The vessel of claim 1, wherein the inner layer and the outer layer degrade when exposed to water.

3. The vessel of claim 1, wherein the inner layer is designed to degrade sufficiently to unseal the inner cavity within a period of 1 to 2 days.

4. The vessel of claim 3, wherein the outer layer is designed to retain structural integrity over a period of 20-40 days after the inner layer degrades sufficiently to unseal the inner cavity.

5. The vessel of claim 1, wherein the outer layer comprises a screen or a mesh.

6. The vessel of claim 1, wherein the inner cavity has a volume of between 1.27 cm³ and 20.32 cm³.

7. The vessel of claim 1, wherein the one or more plants propagants comprises one or more seeds.
